(19) United States
(12) Patent Application Publication
(10) Pub. No.: US 2007/0118432 A1
(43) Pub. Date: May 24, 2007

(54) Systems and methods for optimizing revenue in search engine auctions

(76) Inventors: Vijay Vazirani, Atlanta, GA (US); Umesh Vazirani, Berkeley, CA (US); Amin Saberi, Palo Alto, CA (US); Aranvak Mehta, Atlanta, GA (US)

Correspondence Address: THOMAS, KAYDEN, HORSTEMEYER & RISLEY, LLP, 100 GALLERIA PARKWAY, NW, STE 1750, ATLANTA, GA, 30339-5948, US

(21) Appl. No.: 11/285,126

(22) Filed: Nov. 21, 2005

(51) Int. Cl. G06Q 30/00

(52) U.S. Cl. 705/26

(57) ABSTRACT

Systems and methods are disclosed for improving the allocation of an on-line query to a bidder. One method comprises determining a tradeoff value corresponding to the bidder and rating the bidder in relation to other bidders according to the tradeoff value. Another method comprises receiving a query, assigning a bid value to the bidder, determining a tradeoff value corresponding to the bidder, calculating a tradeoff product of the bid value and the tradeoff value, and allocating the query to the bidder if the tradeoff product is greater than tradeoff products corresponding to other bidders.

### TECHNICAL FIELD

The present disclosure generally relates to online advertising. More particularly, algorithms are disclosed for assigning queries to bidders in order to optimize revenue.

### BACKGROUND

Linking advertisements to search terms allows for correlation between advertisers and targeted audiences. Internet search engine companies have revolutionized not only the use of the Internet by individuals, but also the way businesses advertise to consumers. Instead of flooding consumers with unwanted ads, search engines open up the possibility of a dialogue between consumers and businesses, with consumers typing in keywords, called “ADWORDS®” by GOOGLE® for example, that reveal what they are looking for and search engines displaying highly targeted ads relevant to the specific query. (ADWORDS® and GOOGLE® are registered trademarks of Google, Inc.)

The market for ADWORDS® and other keywords is essentially a large auction where businesses place bids for individual keywords, together with limits specifying their maximum daily budget. The search engine company earns revenue from businesses when it displays their ads in response to a relevant search query (if the user actually clicks on the advertisement, for example). Most of the revenues of search engine companies are derived in this manner.

It is well known that Internet companies are able to open up new markets by tapping into the fat tails of distributions. This holds for search engine companies as well. The advertising budgets of companies and organizations follows a power law distribution, and unlike conventional advertising, search engine companies are able to cater to low budget advertisers on the fat tail of this distribution.

Existing models separate ads from search results, with advertisers choosing one or more search keywords to which they would link their ads. The advertisers bid what they are willing to pay each time someone clicks on the link. The ad links generally appear in a separate list next to the search results and ranked in order of the bids. Other factors such as click-through rates or time of day, for example, may also be taken into account. Bids for keywords can range from a few cents per click, for obscure terms, to $100 or more, for highly desired terms. The entire system is in constant flux and a new bidding sequence ensues within the auction framework each time someone performs a search.

There exists a need to allocate user queries to bidders in a manner that maximizes the total revenue received.

### SUMMARY

Systems and methods are disclosed for rapidly allocating user queries to bidders in a manner that keeps bidders alive for the duration of the auction. Algorithms are disclosed for maximizing revenue for the search company via utilizing tradeoff functions to achieve competitive ratios when assigning queries to bidders.

An exemplary method, among others, for improving the allocation of an online query to a bidder comprises determining a tradeoff value corresponding to the bidder and rating the bidder in relation to other bidders according to the tradeoff value.

Another exemplary method for allocating an on-line query to a bidder, comprises receiving the query, assigning a bid value to the bidder, determining a tradeoff value corresponding to the bidder, calculating a tradeoff product of the bid value and the tradeoff value, and allocating the query to the bidder if the tradeoff product is greater than tradeoff products corresponding to other bidders.

An exemplary system, among others, for allocating an on-line query to a bidder comprises means for receiving the query, means for assigning a bid value to the bidder, means for determining a tradeoff value corresponding to the bidder, means for calculating a tradeoff product of the bid value and the tradeoff value, and means for allocating the query to the bidder if the tradeoff product is greater than tradeoff products corresponding to other bidders.

Other system, methods, features, and advantages of the present invention will be or become apparent to one with skill in the art upon examination of the following drawings and detailed description. It is intended that all such additional systems, methods, features, and advantages be included within this description, be within the scope of the present disclosure, and be protected by the accompanying claims.

### BRIEF DESCRIPTION OF THE DRAWINGS

FIG. 1 is a diagram illustrating a system for allocating queries to bidders.

FIG. 2 is a flowchart illustrating a method for assigning queries to bidders according to the system in FIG. 1.

FIG. 3 is a flowchart illustrating a method for determining the tradeoff product of a bid value and a tradeoff value for n bidders for use in the flowchart of FIG. 2.

FIG. 4 is an illustration of money spent by bidders from the system of FIG. 1.

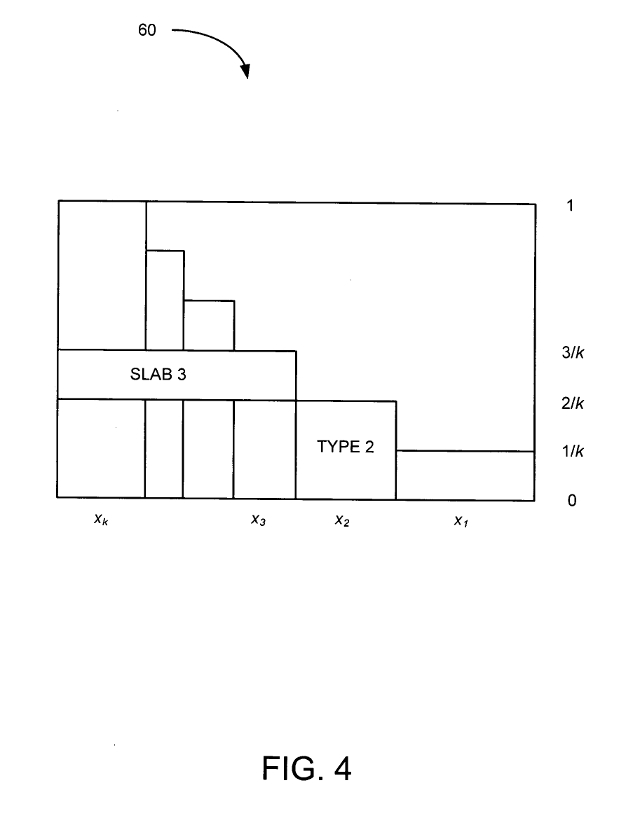

### DETAILED DESCRIPTION

Systems and methods are disclosed for rapidly allocating user queries to bidders in a manner that keeps bidders alive for the duration of the auction. Algorithms are disclosed for maximizing revenue for the search company via utilizing tradeoff functions to achieve competitive ratios when assigning queries to bidders. The systems and methods are disclosed by way of example in the context of advertisers bidding for specific advertisement locations in relation to specific queries. It should be noted that the systems and methods disclosed also find use for other environments, in addition to advertising, where bidding is involved. Additionally, the systems and methods also find use for online sales where buyers have limited budgets, even though bidding may not be involved. Thus the bidders described below could also be thought of as buyers.

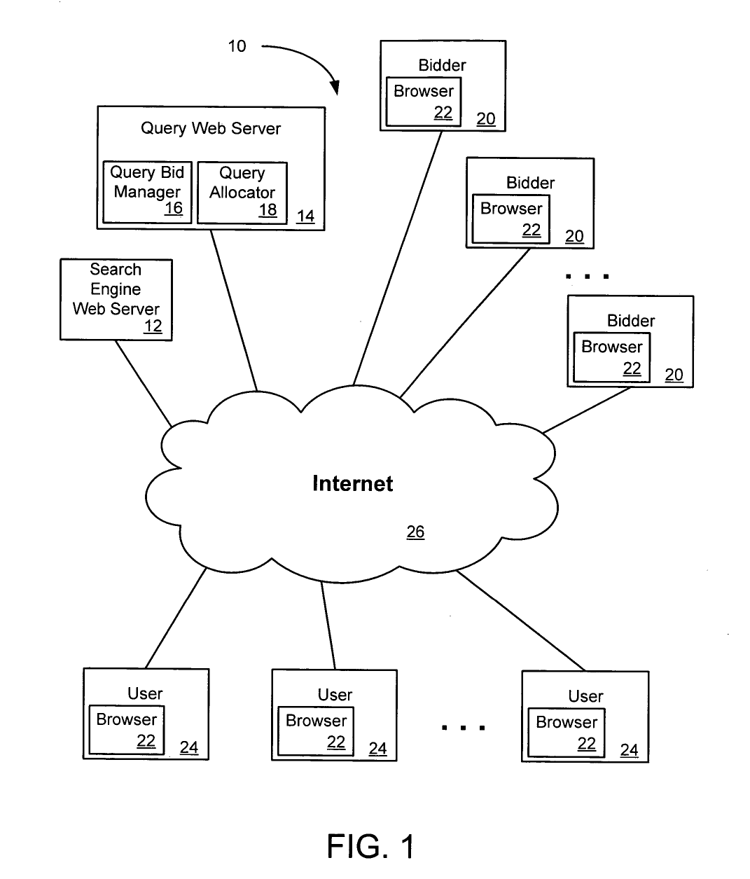

FIG. 1 is an example of a distributed system 10 configured as client/server architecture used for allocating queries to bidders. A client is a member of a class or group that uses the services of another class or group to which it is not related. For example, in the context of a computer network, such as the Internet 26, a client is a process, such as a program or task, among others, that requests a service which is provided by another process, known as a server program. The client process uses the requested service without having to know any working details about the other server program or the server itself. In networked systems, a client process usually runs on a computer that accesses shared network resources provided by another computer running a corresponding server process. However, it should also be noted that it is possible for the client process and the server process to run on the same computer.

A server is typically a remote computer system that is accessible over a communications medium such as the Internet 26. The client process may be active in a second computer system, and communicate with the server process over a communications medium that allows multiple clients to take advantage of the information-gathering capabilities of the server. Thus, the server essentially acts as an information provider for a computer network.

FIG. 1 shows a distributed system 10 comprising a plurality of servers such as a search engine web server 12, a query web server 14, and client computers such as bidders 20, and users 24, all of which are connected to a network such as the Internet 26. It should be noted that multiple search engine web servers 12 and query web servers 14 could be utilized. Although the system and method of the present invention is specifically useful for the Internet 26, it should be understood that the search engine web server 12, query web server 14, bidders 20, and users 24 may be connected together through one or more of a number of different types of networks. Such networks may include local area networks (LANs), other wide area networks (WANs), and regional networks accessed over telephone lines, such as commercial information services, among others. The client and server processes may even comprise different programs executing simultaneously on a single computer.

The bidder 20 computers and the user 24 computers can be conventional personal computers (PCs), laptops, workstations, or other type computer systems. Each computer typically includes one or more processors, memories, input/output devices, and a network interface. The network interface could be an ethernet card, a conventional modem, a DSL modem, or wireless connection, among others. The search engine web server 12 and the query web server 14 can be similarly configured. However, search engine web servers 12 and query web servers 14 may each include many computers connected by a separate private network.

The client computers such as bidders 20 and users 24 can execute web browser programs 22, such as NAVIGATOR, or EXPLORER, among others, to access the programs available on the search engine web server 12 or the query web server 14. The web browser programs 22 allow the users to enter addresses of specific web pages to be retrieved. These addresses are referred to as Uniform Resource Locators, or URLs. In addition, once a page has been retrieved, the browser programs 22 can provide access to other pages or records when the user “clicks” on hyperlinks to other web pages. Such hyperlinks are located within the web pages and provide an automated way for the user to enter the URL of another page and to retrieve that page. The pages can be data records including as content plain textual information, or more complex digitally encoded multimedia content, such as software programs, graphics, audio signals, videos, and so forth.

In a preferred embodiment of the present invention, shown in FIG. 1, client computers such as user 24 communicate through the Internet 26 with various network information providers, including search engine web server 12, using the functionality provided by a HyperText Transfer Protocol (HTTP), although other communications protocols, such as FTP, SNMP, TELNET, and a number of other protocols known in the art, may be used. Preferably, search engine web server 12 is located on the World Wide Web. Of course, multiple search engine web servers 12 may be used in the invention.

As discussed above, at least two types of servers are contemplated in a preferred embodiment of the present invention. The first server contemplated is a search engine web server 12 which would typically comprise one or more computer storage mediums (not shown), one or more processing systems (not shown) and one or more databases (not shown). Conventional browsers 22, running on client computers such as users 24, may be used to access information on the World Wide Web through the search engine web server 12. A search engine program permits network users 24, upon navigating to the search engine web server 12 URL or sites on other web servers capable of submitting queries to the search engine web server 12 through their browser program 22, to type keyword queries to identify pages of interest among the millions of pages available on the World Wide Web.

Users 24 at client computers may comprise searchers seeking specific information on the World Wide Web. The users 24 may access, through their browsers 22, a search engine web page residing on search engine web server 12. The search engine web page includes a query box in which a user 24 types a search term comprising one or more keywords. Alternatively, the user 24 may query the search engine web server 12 through a query box hyperlinked to the search engine web server 12 and located on a web page stored at a remote web server. When the user 24 has finished entering the search term, the user 24 may transmit the query to the search engine web server 12 by clicking on a provided hyperlink. The search engine web server 12 will then generate a search result list page and transmit this page to the user 24.

The search engine web server 12 generates a search result list that includes, at least in part, relevant entries obtained from and formatted by the results of the query entered by a user 24. The search engine ranks the search result list in order of relevance according to algorithms utilized by the search engine program. The search engine web server 12 generates a list of hypertext links to documents or locations on the World Wide Web that contain information relevant to search terms entered by the user 24. The search engine web server 12 transmits this list, in the form of a web page, to the network user 24, where it is displayed on the browser 22. Additionally, advertisements may be located on the web page transmitted by the search engine web server 12. Typically, advertisements are located in a column to the right of the search results. Of course, the advertisements may also be located in other locations on the search results web page.

The user 24 may click on the hypertext links associated with each listing on the search results page to access the corresponding web pages. The hypertext links may access web pages anywhere on the Internet 26, and include hyperlinks to advertiser web pages located on advertiser web servers.

Search engine web server 12 is connected to the Internet 26. In a preferred embodiment of the present invention, search engine web server 12 includes a search database (not shown) comprised of search listing records used to generate search results in response to user queries. In addition, search engine web server 12 may also be connected to the query web server 14 discussed below. Query web server 14 may also be connected to the Internet.

The second server type contemplated is a query web server 14, which also would typically comprise one or more computer storage mediums (not shown), one or more processing systems (not shown) and one or more databases (not shown). Conventional browsers 22, running on client computers such as bidders 20, may be used to access information available through the query web server 14. The query web server 14 provides programs such as a query bid manager 16 and a query allocator 18. Upon navigating to the query web server 14 URL through their browser program 22, for example, a bidder 20 may utilize the query bid manager 16 to place bids for the keywords that will be queried through the search engine web server 12. The query allocator 18 uses algorithms such as those discussed below to determine which bidders 20 are awarded the queries and allocates the corresponding advertisements to appropriate locations on the web page with the search results.

Conventional browser programs 22, running on client computers such as bidder 20, may be used to access bidder account information stored on query web server 14. Preferably, access to the query web server 14 is accomplished through a firewall, not shown, which protects the account information and other information from external tampering. Additional security may be provided via enhancements to the standard communications protocols such as Secure HTTP or the Secure Sockets Layer.

Advertisers, such as bidders 20, desire to have their advertisements placed in the most prominent location on the search results web page, with the goal of attracting users 24 to visit their respective web sites. Thus, advertisers bid on the search queries in order to have their respective advertisements displayed. The system 10 shown in FIG. 1 can be used for allocating queries to bidders 20. Bidders 20 participate in a competitive bidding process with other advertisers or bidders. A bidder 20 may bid on any number of search terms relevant to the content of the advertiser's web site. Bidders 20 utilize a conventional browser 22 to access the query bid manager 16 on the query web server 14 through the Internet 26. Since users search for information through the search engine web server 12 via one or more keywords, bidders 20 may bid on various keywords to have one or more advertisements placed on the search results web page provided by the search engine web server 12. Additionally, bidders 20 may select an amount to bid for each keyword and also a daily budget to be spent in the accumulation of queries with which to have their keywords associated. The budget could just as easily be in some other time increment, such as hourly or weekly, for example. Of course, the bid price for query allocation will not be charged, and thus deducted from the bidder 20 daily budget, unless the user 24 actually clicks-through on the advertisement. When the daily budget is exhausted, no more advertisements will be displayed for that bidder 20. It should be clear that at least two bidders will normally be placing bids for query allocations, though preferably many more than two. While revenue can be collected when an advertisement is clicked, it should also be noted that revenue collection can also be dependent on other factors, such as charging per impression, or charging for sales, among others. One of skill in the art will understand that revenue collection could depend on any number of factors.

The query allocator 18 receives the search result list from the search engine web server 12 and assigns the queries to the bidders 20. After queries are assigned to the bidders 20, the respective advertisements of each bidder 20 will be located in the appropriate location on the search results web page according to the priority assigned to each bidder 20 by the query allocator 18. The search results web page will then be transferred to the browser 22 of user 24. Of course, the newly created search results web page with advertisements may be transferred from either the search engine web server 12 or the query web server 14. The query allocator 18 can assign the queries to bidders 20 and then transfer the results to the search engine web server 12 so that advertisements can be added to the search results web page, or the query web server 14 can receive the search results web page from the search engine web server 12, add the appropriate advertisements, and transfer the search results web page with advertisements to the user 24.

It should be noted that the query bid manager 16 and the query allocator 18 may each be individual programs or modules running on the query web server 14, or each may be a standalone server, for example.

The amount bid by an advertiser, such as bidder 20, comprises a monetary amount that is deducted from the account of the bidder 20 for each time the advertiser's web site is accessed via a hyperlink on the search result web page. A searcher “clicks” on the hyperlink with a computer input device to initiate a retrieval request to retrieve the information associated with the advertiser's hyperlink. Each access or “click” on a search result list hyperlink will be redirected to the query bid manager 16 to associate the “click” with a bidder 20. This redirect action, which is not apparent to the searcher, will access account identification information corresponding to the bidder 20 and deduct the appropriate amount from the daily budget. As noted above, it should be understood that revenue collection could be dependent on factors other than clicking on the advertisement, for example impression, or sales, among others.

The query allocator 18 uses either of two algorithms for allocating search queries in a manner that keeps bidders alive for the duration of the auction, and thus increases the competitiveness of the auction. Both algorithms use a tradeoff function along with the bid value. The first algorithm considers the bid value and the fraction of spent budget for each bidder 20. The second algorithm considers the bid value and the bidder's rank in a random permutation of the bidders 20.

For either algorithm, when a new query arrives, the bid of each bidder i for that query is determined. The bid of each bidder i is c(i). The tradeoff function ψ(f) is applied to each bidder i, where f is either the fraction of spent budget for bidder i or the rank of bidder i in a random permutation of all bidders. The query is then allocated to the bidder i that maximizes the tradeoff product, the product of the bid and the tradeoff function, or c(i)×ψ(f).

One approach for utilizing the algorithms, among others, is discussed in detail in the Appendix and is a linear programming approach based on the following tradeoff function:
Ψ(f)=1−e^{-(1-f)}
It should be understood that other tradeoff functions could also be selected. Thus, there is a tradeoff between either bid versus spent budget or bid versus rank in a random permutation. Under the assumption that bids are small compared to budgets, it is proved (see Appendix) that both algorithms achieve a worst-case competitive ratio of 1−1/e. It should be clear that many monotone functions, including linear functions, could be expected to yield similar performance.

It should also be noted that there is great freedom in the selection of a tradeoff function to be utilized within the algorithms. For example, the tradeoff function could be a monotonically decreasing function. The particular tradeoff function selected would necessarily be tuned to the particular application.

It should also be understood that the fraction of spent budget is trivially related to the fraction of unspent budget. Algorithms could therefore utilize the fraction of unspent budget in a similar manner. It should be further emphasized that other heuristics could be utilized in relation to the fraction of spent budget, for instance.

When returning results of a specific query, the search engine web server 12 needs to immediately determine what advertisements to display. The competitive ratio of an algorithm that awards each query to the highest bidder is 1/2, which is tight. The two algorithms disclosed above, one deterministic and one randomized, allow for assigning search queries to bidders 20 in a manner that maximizes total revenue while respecting the budgets of the respective bidders. The bidders 20 are kept alive for the duration of the auction, thus making the auction more competitive and bidders 20 do not spend their entire budget prematurely. Both algorithms are simple and time efficient.

It should be noted that the systems and methods disclosed herein likewise apply to any solution regarding keywords or other similar objects and requiring allocation of queries to bidders 20. While the embodiments herein are discussed in relation to search engines, it should be noted that the systems and methods disclosed can also be applied to any type of paid advertising mechanism in which bids and budgets are relevant, including but not limited to advertising on content pages, for example. In those cases, the content provider replaces the search engine. These systems and methods can also be applied to online auctions such as ebay or online sellers such as amazon.com or other mechanisms for online allocation of resources to budget restricted buyers.

It should also be noted that the highest bidder 20 for a particular keyword is not necessarily allocated the query result. The query result is allocated to the bidder that maximizes the tradeoff product, the product of the bid and the tradeoff function. Utilizing the fraction of spent budget (or the bidder's rank in a random permutation) as a tradeoff against the bid value results in an allocation of search queries that is more competitive.

Gaming by advertisers is a serious problem in online advertisement auctions. These algorithms provide some resilience against gaming schemes. One such scheme exploits the second-price auction to deplete the competitor's budget. This scheme places a bid just less than the winning bid, thus quickly depleting the competitor's budget. Once the competitor is eliminated, the keyword can be obtained at a low bid. The algorithms disclosed herein often award query words to the ghost bidder utilizing this and other gaming schemes, since the highest bidder does not necessarily win the auction, thereby also depleting the gaming bidder's budget.

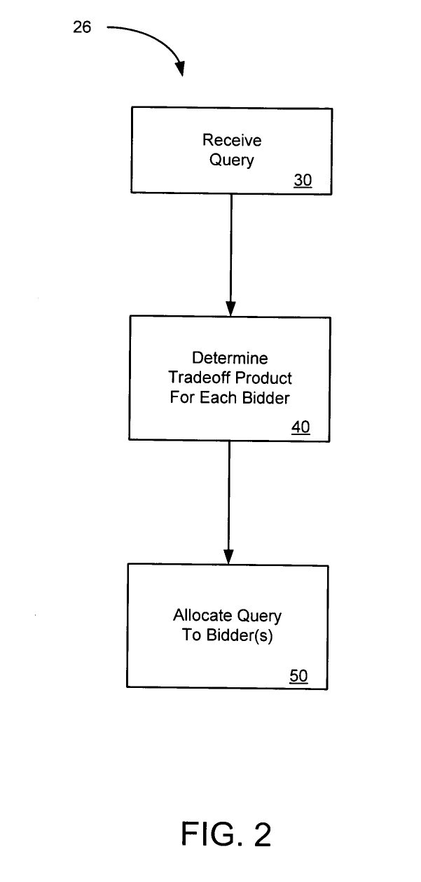

FIG. 2 is a flowchart 26 illustrating the allocation of queries to the bidder(s) 20. A query is received from a user 24 in step 30. Each bidder 20 that has placed a bid for the keyword or keywords involved in the query received in step 30 will be considered for having their advertisement displayed with the results of the query. Using either of the two algorithms discussed above, a tradeoff product is determined for each bidder in step 40. The calculation of the tradeoff product is discussed in greater detail below in relation to flowchart 41. Step 50 allocates the query to the bidder with the largest weighted bid product. For multiple advertising locations on the search results web page, the second location could go to the bidder with the next largest tradeoff product, and so forth until each advertising location is allocated.

It should also be noted that the algorithms disclosed herein should not be limited to auctions where the only factors to be considered are the bid value and the tradeoff function utilized. The algorithms can and should be combined with heuristic methods for tuning their performance in allocating queries.

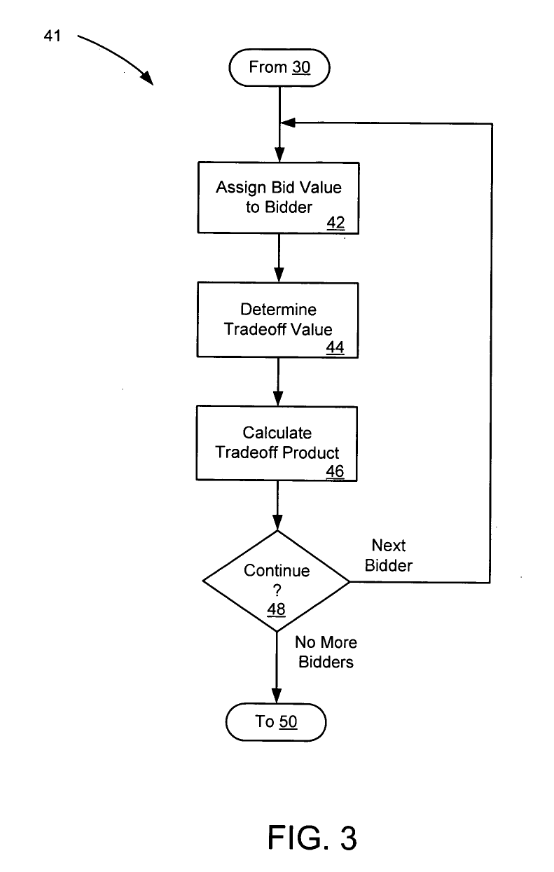

FIG. 3 is a flowchart 41 illustrating the determination of a tradeoff value according to step 40 as shown in flowchart 26 in FIG. 2. After the query is received in step 30, a bid value is assigned to a bidder in step 42. The tradeoff value for that bidder is determined in step 44 according to one of the two algorithms discussed above. The tradeoff product is determined in step 46 by multiplying the bid value and the tradeoff value. Step 48 determines whether any bidders remain to be considered. Once tradeoff products have been determined for all bidders, the query is allocated to the bidder with the largest tradeoff product as discussed previously.

Utilizing the first algorithm, the tradeoff value for each bidder would be determined according to
Ψ(f)=1−e^{-(1-f)} Equation (1)
where f corresponds to the spent fraction of that bidder's budget. A tradeoff value is determined for each bidder according to equation (1). The resulting tradeoff value is then multiplied by the bid for that bidder. The bidder with the largest tradeoff product, the product of bid value and tradeoff value will be allocated the query.

Likewise, utilizing the second algorithm, the tradeoff value for each bidder would be determined according to

$$ψ ( r ) = 1 - {( 1 - \frac{1}{n} )}^{n - r + 1} \qquad Equation ( 2 )$$

where r is the rank of the bidder in a random permutation of n bidders. The n bidders are randomly permuted and the rank r corresponds to the bidder's position in this permutation. Similar to the first algorithm, a tradeoff value is determined for each bidder according to equation (2). The resulting tradeoff value is then multiplied by the bid for that bidder. The bidder with the largest tradeoff product, the product of bid value and tradeoff value will be allocated the query.

It is important to note that 1−1/e is the worst case performance of the algorithms when using the tradeoff function discussed in the Appendix, and one would expect them to perform much better in a statistical setting, such as if the queries are chosen from an arbitrary but fixed probability distribution. Indeed, the algorithm could be expected to exhibit a self-adaptive behavior, performing near optimally on slowly evolving statistical behavior of the query sequence, while protecting against sudden spikes by providing worst case guarantees.

The first algorithm needs to keep track of the money spent by each bidder, but the second one does not and is therefore useful if, for one example among others, a search engine company is using a distributed set of servers which periodically coordinate the money spent by each bidder.

It should also be noted that the mathematical guarantees that the algorithms provide are worst-case in nature. However, the main idea also applies to inputs coming from (unknown and dynamically changing) distributions. The performance of the algorithm is expected to be much better than the worst-case ratio of 1−1/e under such probabilistic inputs.

To further improve the performance in practice, the following refinement of the basic algorithm can be used: each bidder is assigned a weight, and the effective bid for a keyword is defined to be the product of the actual bid and the bidder's weight (more generally the weights could be assigned to each bidder/keyword pair). Queries are now allocated using effective bids in place of actual bids in the previously described algorithms.

Experience suggests that if the queries are drawn from an arbitrary but fixed probability distribution then there is some set of weights for the bidders under which the refined algorithm would perform almost as well as the optimal off-line algorithm, which knows all queries in advance.

The following simple heuristic is proposed for determining the appropriate weights for the bidders: start with some initially assigned weights, all weights equal to 1, for example. Set a suitably short window of time, T. Adjust the weights of the bidders after each T step window as follows: if a bidder spends less than his fair share of his budget during the last T steps, then adjust his weight upwards, and if he spends more than his fair share adjust his weight downwards. (One way to interpret “fair share” is that for each window, the fraction of budget spent of each bidder should be equal.)

If the queries are drawn from a fixed probability distribution, then this process quickly converges to the desired set of weights. If the probability distribution from which the queries are selected switches once in a while, the above heuristic will still converge to the correct set of weights, and therefore adapts to changing conditions. Other approaches can also be considered for updating the bidders' weights, for example, using a linear programming based approach to solve for the correct set of weights whenever the bidders spend very non-uniformly during a time window (indicating that the distribution has changed suddenly and the bidder weights must be radically altered).

It will be appreciated from the description herein that the system and method of the present invention may be implemented in software and can be stored on any computer readable medium for use by or in connection with any computer related system or method. In the context of this document, a computer readable medium is an electronic, magnetic, optical, or other physical device or means that can contain or store a computer program for use by or in connection with a computer related system or method. The allocation of queries to bidder(s) can be embodied in any computer-readable medium for use by or in connection with an instruction execution system, apparatus, or device, such as a computer-based system, processor-containing system, or other system that can fetch the instructions from the instruction execution system, apparatus, or device and execute the instructions. In the context of this document, a “computer-readable medium” can be any means that can store, communicate, propagate, or transport the program for use by or in connection with the instruction execution system, apparatus, or device. The computer readable medium can be, for example but not limited to, an electronic, magnetic, optical, electromagnetic, infrared, or semiconductor system, apparatus, device, or propagation medium. More specific examples (a nonexhaustive list) of the computer-readable medium would include the following: an electrical connection (electronic) having one or more wires, a portable computer diskette (magnetic), a random access memory (RAM) (electronic), a read-only memory (ROM) (electronic), an erasable programmable read-only memory (EPROM, EEPROM, or Flash memory) (electronic), an optical fiber (optical), and a portable compact disc read-only memory (CDROM) (optical). Note that the computer-readable medium could even be paper or another suitable medium upon which the program is printed, as the program can be electronically captured, via for instance optical scanning of the paper or other medium, then compiled, interpreted or otherwise processed in a suitable manner if necessary, and then stored in a computer memory.

It should be emphasized that the above-described embodiments of the present invention, particularly, any “preferred” embodiments, are merely possible examples of implementations, merely set forth for a clear understanding of the principles of the invention. Many variations and modifications may be made to the above-described embodiment(s) of the invention without departing substantially from the spirit and principles of the invention. All such modifications and variations are intended to be included herein within the scope of the present disclosure and protected by the following claims.

### APPENDIX

The competitive ratio of an algorithm that awards each query to the highest bidder is 1/2, which is tight. The two algorithms disclosed herein, one deterministic and one randomized, achieve competitive ratios of 1−1/e, under the assumption that bids are small compared to budgets. Both algorithms are simple and time efficient.

The ADWORDS® problem is a generalization of the online bipartite matching problem: the special case where each advertiser makes unit bids and has a unit daily budget is precisely the online matching problem. Even in this special case, the greedy algorithm achieves a competitive ratio of 1/2. The algorithm that allocates each query to a random interested advertiser does not do much better—it achieves a competitive ratio of 1/2+O(log n/n).

In R. M. Karp, U. V. Vazirani and V. V. Vazirani, An Optimal Algorithm for Online Bipartite Matching, PROCEEDINGS OF THE 22ND ANNUAL ACM SYMPOSIUM ON THEORY OF COMPUTING, 1990, which is incorporated herein by reference in its entirety and hereinafter referred to as Karp, a randomized algorithm for the online matching problem achieving a competitive ratio of 1−1/e is given. Their algorithm, called RANKING, fixes a random permutation of the bidders in advance and breaks ties according to their ranking in this permutation. They further showed that no randomized online algorithm can achieve a better competitive ratio.

In another direction, Bala Kalyanasundaram and Kirk R. Pruhs, An Optimal Deterministic Algorithm for Online b-matching, THEORETICAL COMPUTER SCIENCE, 233(1-2):319-325, 2000, which is incorporated herein by reference in its entirety and hereinafter referred to as Kalyanasundaram 2000, considered the online b-matching problem which can be described as a special case of the ADWORDS® problem as follows: each advertiser has a daily budget of b dollars, but makes only 0/1 dollar bids on each query. Their online algorithm, called BALANCE, awards the query to that interested advertiser who has the highest unspent budget. They show that the competitive ratio of this algorithm tends to 1−1/e as b tends to infinity. They also prove a lower bound of 1−1/e for deterministic algorithms.

The offline version of the ADWORDS® problem is NP-hard. The best known approximation algorithm is given by N. Andelman and Y. Mansour, Auctions With Budget Constraints, 9TH SCANDINAVIAN WORKSHOP ON ALGORITHM THEORY (SWAT), pp. 26-38, 2004, which is incorporated herein by reference in its entirety and referred to hereinafter as Andelman, and achieves a factor of 1−1/e, for arbitrary bid values, via randomized rounding of an LP solution. With the assumption that bids are small compared to the budgets, LP rounding gives a 1−ε algorithm (with ε>0 small).

To generalize the algorithms of Kalyanasundaram 2000 and Karp to arbitrary bids, it is instructive to examine the special case with bids restricted to {0, 1, 2}. The natural algorithm to try assigns each query to a highest bidder, using the previous heuristics to break ties (largest remaining budget/highest ranking in the random permutation). Two examples to be discussed below show that both these algorithms achieve competitive ratios strictly smaller and bounded away from 1−1/e.

This indicates the need to consider a much more delicate tradeoff between the bid versus the remaining budget in the first case, and the bid versus the position in the random permutation in the second. The correct tradeoff function is derived by a novel LP-based approach. The resulting algorithms are very simple and are based on the tradeoff function Ψ(f)=1−e^{-(1-f)} given above.

Algorithm 1:

Allocate the next query to the bidder i maximizing the product of his bid and ψ(T(i)), where T(i) is the fraction of the bidder's budget which has been spent so far, i.e.

$$T ( i ) = \frac{{m}_{i}}{{b}_{i}} ,$$

where bᵢ is the total budget of bidder i and mᵢ is the amount of money spent by bidder i.
Algorithm 2:

Start by permuting the bidders at random. Allocate the next query to the bidder maximizing the product of his bid and ψ(r/n), where r is the rank of this bidder in the random order and n is the number of bidders.

Algorithm 1 and algorithm 2 both assume that the daily budget of bidders is large compared to bids.

### Derivation of the Correct Tradeoff Function

Derivation of the correct tradeoff function requires introduction of a tradeoff-revealing family of LP's. This concept builds upon the notion of a factor-revealing LP, as given in K. Jain, M. Mahdian, E. Markakis, A. Saberi, and V. Vazirani, Greedy Facility Location Algorithms Analyzed Using Dual Fitting with Factor-Revealing LP, J. ACM, 2003, which is incorporated herein by reference in its entirety and referred to hereinafter as Jain. A factor-revealing LP is used to analyze the performance in the special case when all bids are equal. This provides a simpler proof of the Kalyanasundaram 2000 result.

An LP, L, whose constraints (upper bounding the number of bidders spending small fractions of their budgets) are satisfied at the end of a run of BALANCE on any instance π (sequence of queries) of the equal bids case is given. The objective function of L gives the performance of BALANCE on π. Hence the optimal objective function value of L is a lower bound on the competitive ratio of BALANCE. How good the lower bound is depends on the constraints captured in L. The resulting bound computed by this LP is 1−1/e which is tight. Indeed, for some fairly sophisticated algorithms a factor-revealing LP is the only way known of deriving a tight analysis, as shown in Jain 2003, and N. Bansal, L. Fleischer, T. Kimbrel, M. Mahdian, B. Schieber, and M. Sviridenko, Further Improvements in Competitive Guarantees for QoS Buffering, ICALP, VOLUME 3142 of LNCS, pp. 196-207, 2004, which is incorporated herein by reference in its entirety and referred to hereinafter as Bansal.

Dealing with arbitrary bids is considerably more challenging, since there is no information for meaningful constraints reflecting the allocation of queries to bidders on a arbitrary instance π. A rather counterintuitive approach is used. We proceed by fixing a monotonically decreasing tradeoff function ψ, as well as the sequence of queries π, and write a new LP L(π, ψ) for algorithm 1 using tradeoff function ψ run on instance π. Once the algorithm is specified as well as the sequence of queries, the actual allocation of queries to bidders is completely determined. L(π, ψ) is identical to the factor revealing LP L except that the right hand side of each inequality is replaced by the actual value attained for this constraint in this run of the algorithm. These LP's L(π, ψ)—whose inequalities are just relaxed tautologies with unknown right hand sides—do indeed provide non-trivial insight. The family of LP's captures some of the structure of the problem which is revealed by considering the family of dual linear programs D(π, ψ).

Notice that L(π, ψ)differs from L only in that a vector Δ(π, ψ) is added to the right hand side of the constraints. Therefore, the dual programs D(π, ψ) differ from the dual D of L only in the objective function, which is changed by Δ(π, ψ)·y, where y is the vector of dual variables.

Hence the dual polytope for all LP's in the family is the same as that for D. Moreover, it is shown that D and each LP in the family D(π, ψ) attains its optimal value at the same vertex, y* of the dual polytope (by showing that the complementary slackness conditions are satisfied). Finally, we show how to use y* to define ψ in a specific manner so that Δ(π, ψ)·y*≦0 for each instance π (observe that this function ψ does not depend on π and hence it works for all instances). This function is precisely the function used in algorithm 1. This ensures that the performance of algorithm 1 on each instance matches that of BALANCE on unit bid instances and is at least 1−1/e.

We call this ensemble L(π, ψ), a tradeoff revealing family of LP's. Once the competitive ratio of the algorithm for the unit bid case is determined via a factor-revealing LP, this family helps to find a tradeoff function that ensures the same competitive ratio for the arbitrary bids case.

The same proof outline also applies to algorithm 2 once the analysis of Karp is suitably simplified and cast in terms of linear constraints.

### Problem Definition

The ADWORDS® problem is the following: There are N bidders, each with a specified daily budget bⁱ. Q is a set of query words. Each bidder i specifies a bid C_{iq} for every word qεQ. A sequence q₁q₂ . . . q_{M} of query words qⱼεQ arrive online during the day, and each query qⱼ must be assigned to some bidder i (for a revenue of cᵢqⱼ). The objective is to maximize the total revenue at the end of the day while respecting the daily budgets of the bidders.

It is assumed throughout that the bids are small compared to the budgets, i.e., maxᵢⱼcᵢⱼ is small compared to minᵢbᵢ. For the applications of this problem, this is a reasonable assumption.

An online algorithm is said to be α-competitive if for every instance, the ratio of the revenue of the online algorithm to the revenue of the best off-line algorithm is at least α. While presenting the algorithms and proofs, simplifying assumptions are made that the budgets of all bidders are equal (assumed unit) and that the best offline algorithm exhausts the budget of each bidder. These assumptions are relaxed when analyzing more realistic models.

### A Discretized Version of Algorithm 1

First, a greedy algorithm that maximizes revenue accrues at each step is considered. It is easy to see that this algorithm achieves a factor of ½, as is shown in B. Lehman, D. Lehman, and N. Nisan, Combinatorial Auctions With Decreasing Marginal Utilities, PROCEEDINGS OF THE 3RD ACM CONFERENCE ON ELECTRONIC COMMERCE, pp. 18-28, 2001, which is incorporated herein by reference in its entirety and referred to hereinafter as Lehman. Moreover, this is tight as illustrated by the following example with only two bidders and two query words: Suppose both bidders have unit budget. The two bidders bid c and c+ε respectively on query word q, and they bid 0 and c on query word q′. The query sequence consists of a number of occurrences of q followed by a number of occurrences of q′. The query words q are awarded to bidder 2, and are just enough in number to exhaust his budget. When query words q′ arrive, bidder 2′s budget is exhausted and bidder 1 is not interested in this query word, and they accrue no further revenue.

Algorithm 1 rectifies this situation by taking into consideration not only the bids but also the unspent budget of each bidder. For the analysis it is convenient to discretize the budgets as follows: pick a large integer k, and then discretize the budget of each bidder into k equal parts (called slabs) numbered 1 through k. Each bidder spends money in slab j before moving to slab j+1.

Definition:

At any time during the run of the algorithm, we will denote by slab(i) the currently active slab for bidder i.

Let ψ: [1 . . . k]→R⁺ be the following (monotonically decreasing) function:
ψₖ(i)=1−e^{-(1-i/k)}
Note that ψₖ→ψ as k→∞
Discrete Algorithm 1

When a new query arrives, let the bid of bidder i be c(i). Allocate the query to the bidder i who maximizes c(i)×ψₖ(slab(i)).

Note that in the special case when all the bids are equal, the algorithm works in the same way as the BALANCE algorithm, for any monotonically decreasing tradeoff function.

### Analyzing Balance Using a Factor-Revealing LP

The performance of algorithm 1 is analyzed in the special case when all bids are equal. This is exactly the algorithm BALANCE. A simpler analysis of this algorithm using the notion of a factor-revealing LP is now given. This technique was implicit in R. McEliese, E. Rodemich, H. R. Jr., and L. Welch, New Upper Bounds On The Rate Of A Code via the Delstarte-Mac Williams Inequalities, IEEE Trans. Inforrn. Theory, pp. 157-166, 1977, referred to hereinafter as McEliese, M. Goemans and J. Kleinberg, An Improved Approximation Algorithm for the Minimum Latency Problem, MATHEMATICAL PROGRAMMING, 82:111-124, 1998, hereinafter referred to as Goemans, and M. Mahdian, E. Markakis, A. Saberi, and V. Vazirani, A Greedy Facility Location Algorithm Analyzed Using Dual Fitting, RANDOM-APPROX, PP. 127-137, 2001, hereinafter referred to as Mahdian, and was formalized and made explicit in K. Jain, M. Mahdian, and A. Saberi, A New Greedy Approach for Facility Location Problems, STOC, pp. 731-740, 2002, hereinafter referred to as Jain 2002, and Jain 2003, all of which are incorporated herein by reference in their entirety. Extending the analysis to the general case is discussed further below. Another simple proof for BALANCE is provided by Y. Azar and A. Litichevskey, Maximizing Throughput in Multi-Queue Switches, ESA, 2004, which is incorporated herein by reference in its entirety.

It is assumed for simplicity that in the optimum solution, each of the N players spends his entire budget, and thus the total revenue is N (the proof is similar even without this assumption, and is provided below). Recall that BALANCE awards each query to the interested bidder who has the maximum unspent budget. We wish to lower bound the total revenue achieved by BALANCE. Let us define the type of a bidder according to the fraction of budget spent by that bidder at the end of the algorithm BALANCE: say that the bidder is of type j if the fraction of his budget spent at the end of the algorithm lies in the range (j−1)/k,j/k). By convention a bidder who spends none of his budget is assigned type 1.

Bidders of type j for small values of j contribute little to the total revenue. The factor revealing LP for the performance of the algorithm BALANCE will proceed by bounding the number of such bidders of type j.

Lemma 1:

If OPT assigns query q to a bidder B of type j≦k−1, then BALANCE pays for q from some slab i such that i≦j.

The lemma follows immediately from the criterion used by BALANCE for assigning queries to bidders: B has type j≦k−1 and therefore spends at most j/k<1 fraction of his budget at the end of BALANCE. It follows that when query q arrives, B is available to BALANCE for allocating q, and therefore B must allocate q to some bidder who has spent at most j/k fraction of his budget.

For simplicity it is assumed that bidders of type I spend exactly i/k fraction of their budget, and that queries do not straddle slabs. The latter is justified by the fact that bids are small compared to budgets. The total error resulting from this simplification is at most N/k and is negligible, once we take k to be large enough. Now, for i=1, 2, . . . , k−1, let xᵢ be the number of bidders of type(i). Let βᵢ denote the total money spent by the bidders from slab i in the run of BALANCE. FIG. 2 is a diagram 29 showing that βᵢ=N/k, and for 2≦i≦k, βᵢ=N/k−(x₁+ . . . +xᵢ₋₁)/k.
Lemma 2:

$$∀ i , 1 \leq i \leq k - 1 \text{:} {\sum }_{j = 1}^{i} ( 1 + \frac{i - j}{k} ) {x}_{j} \leq \frac{i}{k} N$$

Proof:

By lemma 1,

$${\sum }_{j = 1}^{i} {x}_{j} \leq {\sum }_{j = 1}^{i} {β}_{j} \leq \frac{i}{k} N - {\sum }_{j = 1}^{i} ( \frac{i - j}{k} ) {x}_{j}$$

The lemma follows by rearranging terms.

The revenue of the algorithm is

$$BAL \geq {\sum }_{i = 1}^{k - 1} \frac{i}{k} {x}_{i} + ( N - {\sum }_{i = 1}^{k - 1} x i ) - \frac{N}{k} = N - {\sum }_{i = 1}^{k - 1} \frac{k - i}{k} {x}_{i} - \frac{N}{k}$$

To find a lower bound on the performance of BALANCE we want to find the minimum value that

$$N - {\sum }_{i = 1}^{k - 1} \frac{k - i}{k} {x}_{i} - \frac{N}{k}$$

can take over the feasible {xᵢ}s. This gives the following LP, which we call L. In both the constraints below, i ranges from 1 to k−1.

$$maximize \\ Φ = {\sum }_{i = 1}^{k - 1} \frac{k - i}{k} {x}_{i} \\ subject to \\ ∀ i \text{:} {\sum }_{j = 1}^{i} ( 1 + \frac{i - j}{k} ) {x}_{j} \leq \frac{i}{k} N \\ ∀ i \text{:} {x}_{i} \geq 0 \qquad Equation ( 1 )$$

Let us also write down the dual LP, D, which we will use in the case of arbitrary bids.

$$maximize$$

$${\sum }_{i = 1}^{k - 1} \frac{i}{k} N {y}_{i}$$

$$subject to$$

$$∀ i \text{:} {\sum }_{j = 1}^{k - 1} ( 1 + \frac{j - i}{k} ) {y}_{j} \geq \frac{k - i}{k}$$

$$∀ i \text{:} {y}_{i} \geq 0$$

Define A, b, c, so the primal LP, L can be written as
max c·x s.t. Ax≦b x≧0
and the dual LP, D, can be written as
min b·y s.t. A^{T}y≦c y≧0.
Lemma 3:

As k→∞, the value Φ of the linear programs L and D goes to

$$\frac{N}{ⅇ} .$$

Proof:

$${x}_{i} = \frac{N}{k} {( 1 - \frac{1}{k} )}^{i - 1} for i = 1 , … , k - 1$$

$${y}_{i} = \frac{1}{k} {( 1 - \frac{1}{k} )}^{k - i - 1} for i = 1 , … , k - 1$$

It follows that they satisfy all complementary slackness conditions, hence they are also optimal solutions of the primal and dual programs.

This gives an optimal objective function value of

$$\begin{matrix}Φ = c \cdot {x}^{*} = b \cdot {y}^{*} \\ = {\sum }_{i = 1}^{k - 1} ( \frac{k - i}{k} ) \frac{N}{k} {( 1 - \frac{1}{k} )}^{i - 1} \\ = {N ( 1 - \frac{1}{k} )}^{k}\end{matrix}$$

As we make the discretization finer (i.e., as k→∞) Φ tends to

$$\frac{N}{ⅇ} .$$

Recall that the size of the matching is at least

$$N - Φ - \frac{N}{k} ,$$

hence it tends to N(1−1/e). Since OPT is N, the competitive ratio is at least 1−1/e.

On the other hand one can find an instance of the problem such that at the end of the algorithm all the inequalities of the primal are tight, hence the competitive ratio of BALANCE is exactly 1−1/e.

### A Tradeoff-Revealing Family of LPs for the ADWORDS® Problem

Observe that even if we knew the correct tradeoff function, extending the methods of the previous section is difficult. The problem with mimicking the factor-revealing LP for constant bids is that now the tradeoff between bid and unspent budget is subtle and the basic lemma 1 that allowed us to write the inequalities in the LP no longer holds.

Instead we fix both a monotonically decreasing tradeoff function ψ as well as the instance π of the ADWORDS® problem and write a new LP L(π, ψ) for algorithm 1 using tradeoff function ψ run on the instance π. Of course, once we specify the algorithm as well as the input instance, the actual allocations of queries to bidders is completely determined. In particular, the number αᵢ of bidders of type i is fixed. L(π, ψ) is the seemingly trivial LP obtained by taking the left hand side of each inequality in the factor revealing LP and substituting xᵢ=αᵢ to obtain the right hand side. Formally:

Let α be a k−1 dimensional vector whose ith component is αᵢ Let Aα=1. We denote the following LP by L(π,ψ):
max c·x s.t. Ax≦1x≧0
The dual LP is denoted by D(π,ψ) and is
min l·y s.t. A^{T}_{y}≧c y≧0
It follows that any one LP L(π,ψ) offers no insight into the performance of algorithm 1; after all the right hand sides of the inequalities are expressed in terms of the unknown number of bidders of type i. Nevertheless, the entire family L(π,ψ) does contain useful information which is revealed by considering the duals of these LP's.

Since L(π,ψ) differs from L only in the right hand side, the dual D(π,ψ) differs from D only in the dual objective function; the constraints remain unchanged. Hence soluton y* of D is feasible for D(π,ψ) as well. Recall that this solution was obtained by setting all nontrivial inequalities of D to equality.

Now by construction, if we set all the nontrivial inequalities of LP L(π,ψ) to equality we get a feasible solution, namely α. It follows that α and y* satisfy all complementary slackness conditions. Therefore they are both optimal. Hence we get:

Lemma 4:

For any instance π and monotonically decreasing tradeoff function ψ, y* is an optimal solution to D(π,ψ).

The structure of algorithm 1 does constrain how the LP L differs from L(π,ψ).

As in the analysis of BALANCE, we divide the budget of each bidder into k equal slabs, numbered 1 to k. Money in slab i is spent before moving to slab i+1. We say that a bidder os pf tupe j if the fraction of his budget spent at the end of algorithm 1 lies in the range ((j−1)/k,j/k). By convention a bidder who spends none of his buget is assigned type 1. As before, we make the simplifying assumption (at the cost of a negligible error term) that bidders of type j spend exactly j/k fraction of their budget. Let αⱼ denote the number of bidders of type j. Let βᵢ denote the total money spent by the bidders from slab i in the run of algorithm 1. It follows that β₁=N/k, and for 2≦i≦k, β₁=N/k−(α₁+ . . . +αᵢ₋₁)/k.

We are interested in comparing the performance of algorithm 1 (abbreviated as ALG) with the optimal algorithm OPT. The following definitions focus on some relevant parameters comparing how ALG and OPT treat a query q:

DEFINITION: Let ALG(q) (OPT(q)) denote the revenue earned by algorithm 1 (OPT) for query q. Say that a query q is of type i if OPT assigns it to a bidder of type i, and say that q lies in slab i if algorithm 1 pays for it from slab i.

Lemma 5:
For each query q such that 1≦type(q)≦k−1, OPT(q)ψ(type(q))≦ALG(q)ψ(slab(q)).
Proof:

Consider the arrival of q during the run of algorithm 1. Since type(q)≦k1, the bidder b to whom OPT assigned this query is still actively bidding from some slab j≦type(q) at this time. The inequality in the lemma follows from the criterion used by algorithm 1 to asign queries, together with the monotonicity of ψ.
Lemma 6:

$${\sum }_{i = 1}^{k - 1} ψ ( i ) ( {α}_{i} - {β}_{i} ) \leq 0$$

Proof:

We start by observing that for 1≦i≦k−1:

$${\sum }_{q : type ( q ) = i} OPT ( q ) = {α}_{i}$$

$${\sum }_{q : slab ( q ) = i} ALG ( q ) = {β}_{i}$$

By lemma 5

$${\sum }_{q : type ( q ) \leq k - 1} [ OPT ( q ) ψ ( type ( q ) ) - ALG ( q ) ψ ( slab ( q ) ) ] \leq 0.$$

Next observe that

$$\begin{matrix}{\sum }_{q : type ( q ) \leq k - 1} OPT ( q ) ψ ( type ( q ) ) = {\sum }_{i = 1}^{k - 1} {\sum }_{q : type ( q ) \leq k - 1} OPT ( q ) ψ ( type ( q ) ) \\ = {\sum }_{i = 1}^{k - 1} ψ ( i ) {α}_{i}\end{matrix}$$

$$And$$

$$\begin{matrix}{\sum }_{q : type ( q ) \leq k - 1} ALG ( q ) ψ ( slab ( q ) ) \leq {\sum }_{q : slab ( q ) \leq k - 1} ALG ( q ) ψ ( slab ( q ) ) \\ = {\sum }_{i = 1}^{k - 1} {\sum }_{q : slab ( q ) = i} ALG ( q ) ψ ( i ) \\ = {\sum }_{i = 1}^{k - 1} {ψ}_{i} {β}_{i}\end{matrix}$$

The lemma follows from these three inequalities.

Let α(π,ψ) be a k−1 dimensional vector whose ith component is (α₁−β₁)+ . . . +(αᵢ−βᵢ). The following lemma relates the right hand side of the LPs L and L(π,ψ).

Lemma 7:
l=b+α(π,ψ)
Proof:

Consider the ith components of the three vectors. We need to prove:

$${α}_{1} ( 1 + \frac{i - 1}{k} ) + {α}_{2} ( 1 + \frac{i - 2}{k} ) + … + {α}_{i} = \frac{i N}{k} + ( {α}_{1} - {β}_{1} ) + … + ( {α}_{i} - {β}_{i} )$$

This equation follows using the fact that β₁=N/k−(α₁+ . . . +αᵢ₋₁)/kI.

Theorem 8:

For the ψ function defined as

$${ψ}_{k} ( i ) := {\sum }_{i = 1}^{k - 1} {y}_{j}^{*} = 1 - {( 1 - \frac{1}{k} )}^{k - i + 1}$$

the competitive ratio of Algorithm 1 is

$$1 - \frac{1}{ⅇ} ,$$

as k tends to infinity.
Proof:

By lemma 4, the optimal solution to L(π,ψ) and D(π,ψ) has value l·y*. By lemma 7 this equals (b+Δ). y*≦N/e+Δ·y*. (since b·y*≦N/e, from above).

Now,

$$\begin{matrix}Δ \cdot {y}^{*} = {\sum }_{i = 1}^{k - 1} {y}_{i}^{*} ( ( {α}_{1} - {β}_{1} ) + … + ( {α}_{i} - {β}_{i} ) ) \\ = {\sum }_{i = 1}^{k - 1} ( {α}_{i} - {β}_{i} ) ( {y}_{i}^{*} + … + {y}_{k - 1}^{*} ) \\ = {\sum }_{i = 1}^{k - 1} ( {α}_{i} - {β}_{i} ) ψ ( i ) \\ \leq 0 ,\end{matrix}$$

where the last equality follows from our choice of the function ψ, and the inequality follows from lemma 6. Hence the competitive ratio of algorithm is 1−1/e.

Above, we derived the correct tradeoff function ψ to use in algorithm 1, and in the process also gave a proof that the competitive ratio of the resulting algorithm is 1−1/e. Below we abstract out the essential features of the argument and, starting with the correct tradeoff function, sketch a direct proof of the competitive ratio.

Theorem 9:

The competitive ratio of algorithm 1 is 1−1/e.

Sketch of Proof:

Recall that αᵢ is the number of bidders of type i, and βᵢ is the total amount of money spent by bidders from slab i. We have the following relations from above:

$$∀ i \text{:} {β}_{i} = \frac{N - {\sum }_{j = 1}^{i - 1} {α}_{j}}{k}$$

$${\sum }_{i} ψ ( i ) {α}_{i} \leq {\sum }_{i} ψ ( i ) {β}_{i}$$

Using the above equations and the choice of ψ:

$$ψ ( i ) = 1 - {( 1 - \frac{1}{k} )}^{k - i + 1} \\ we derive \text{:} \\ {\sum }_{i = 1}^{k} {α}_{i} \frac{k - i + 1}{k} \leq \frac{N}{ⅇ} \qquad Equation ( 2 )$$

But the left side of equation (2) is precisely the amount of money left unspent at the end of the algorithm. Hence the factor of the ψ-based algorithm is at least 1−1/e.

### Towards More Realistic Models

The algorithm and analysis can be generalized to the following situations: (1) advertisers have different daily budgets, (2) the optimal allocation does not exhaust all the money of advertisers, and (3) advertisers enter at different times.

We say that the current type of a bidder at some time during the run of the algorithm is j if he has spent between (j−1)/k and j/k fraction of his budget at that time. The algorithm allocates the next query to the bidder who maximizes the product of his bid and ψ (current type).

The proof of the competitive ratio changes minimally. Let the budget of bidder j be Bⱼ. For i=1, . . . , k, define βᵢ^{j} to be the amount of money spent by the bidder j from the interval

$$( \frac{i - 1}{k} {B}_{j} , \frac{i}{k} {B}_{j} )$$

of his budget. Let βᵢ=Σⱼβᵢ^{j}. Let αᵢ be the amount of money that the optimal allocation gets from the bins of final type i. Let α=Σᵢαᵢ, be the total amount of money obtained in the optimal allocation.
Now the relations used in Theorem 9 become

$$∀ i \text{:} {β}_{i} \geq \frac{α - {\sum }_{j = 1}^{i} {α}_{j}}{k}$$

$${\sum }_{i} ψ ( i ) {α}_{i} \leq {\sum }_{i} ψ ( i ) {β}_{i}$$

These two sets of equations suffice to prove that the competitive ratio is at least 1−1/e. We also note that the algorithm and the proof of the competitive ratio remain unchanged even if we allow advertisers to enter the bidding process at any time during the query sequence.

Continuing with the generalization analysis, (4) more than one ad can appear with the results of a query. The most general situation is that with each query we are provided a number specifying the maximum number of ads. If the arriving query q requires n_{q} number of advertisements to be placed, then allocate it to the bidders with the top n_{q} values of the product of bid and ψ (current type). The proof of the competitive ratio remains unchanged.

(5) A bidder pays only if the user clicks on his ad. In order to model this situation, we simply set the effective bid of a bidder to be the product of his actual bid and his click-through rate (CTR), which is the probability that a user will click on his ad. We assume that the click-through rate is known to the algorithm in advance—indeed several search engines keep a measure of the click-through rates of the bidders.

(6) A winning bidder pays only an amount equal to the next highest bid. So far we have assumed that a bidder is charged the value of his bid if he is awarded a query. Some search engine companies charge a lower amount—the next highest bid. There are two ways of defining “next highest bid”: next highest bid for this query among all bids received at the start of the algorithm or only among alive bidders, i.e., bidders who still have money.

It follows that a small modification of our algorithm achieves a competitive ratio of 1−1/e for the first possibility: award the query to the bidder that maximizes next highest bid×ψ(fraction of money spent). Next, let us consider the second possibility. In this case, the offline algorithm will attempt to keep alive bidders simply to charge other bidders higher amounts. If the online algorithm is also allowed this capability, it can also keep all bidders alive all the way to the end and this possibility reduces to the first one.

### A Randomized Algorithm

A generalization of the RANKING algorithm is here defined, which has a competitive ratio of 1−1/e for arbitrary bids, when the bid to budget ratio is small.

We pick a random permutation ρ of the η bidders right at the beginning. For a bidder i, we call ρ(i) the position or rank bidder i in ρ. Again, we choose the same tradeoff function to trade off the importance of the bid of a bidder and his rank in the permutation. We will work with the following discrete version of ψ:

$$ψ ( i ) = 1 - {( 1 - \frac{1}{n} )}^{n - i + 1}$$

Algorithm 2:

Start by picking a random permutation σ of the bidders. For each new query, let the bid of bidder i be b(i). Allocate this query to a bidder with the highest value of the product b(i)×ψ(ρ(i)).

Theorem 10:

The competitive ratio of algorithm 2 is at least 1−1/e.

### A Lower Bound for Randomized Algorithms

Karp proved a lower bound of 1−1/e on the competitive ratio of any randomized online algorithm for the online bipartite matching problem. Also, Kalyanasundaram 2000 proved a lower bound of 1−1/e on the competitive ratio of any online deterministic algorithm for the online b-matching problem, even for large b. By suitably adapting the example used in Karp, we show a lower bound of 1−1/e for online randomized algorithms for the b-matching problem, even for large b. This also resolves an open question from Kalyanasundaram.

Theorem 11:

No randomized online algorithm can have a competitive ration better than 1−1/e for the b-matching problem, for large b.

Proof:

By Yao's Lemma, see A. C. Yao, Probabilistic Computations: Towards a Unified Measure of Complexity, FOCS, pp. 222-227, 1977, which is incorporated herein by reference in its entirety and hereinafter referred to as Yao, it suffices to present a distribution over inputs such that any deterministic algorithm obtains at most 1−1/e of the optimal allocation on the average. Consider first the worst case input for the algorithm BALANCE with N bidders, each with a budget of 1. In this instance, the queries enter in N rounds. There are 1/ε number of queries in each round. We denote by Qᵢ the queries of round i, which are identical to each other. For every i=1, . . . , N, bidders i through N bid ε for each of the queries of round i, while bidders 1 through i−1 bid 0 for these queries. It follows that the optimal assignment is the one in which all the queries of round i are allocated to bidder i, achieving a revenue of N. One can also show that BALANCE will achieve only N(1−1/e) revenue on this input.

Now consider all the inputs which can be derived from the above input by permutation of the numbers of the bidders and take the uniform distribution D over all these inputs. Formally, D can be described as follows: Pick a random permutation π of the bidders. The queries enter in rounds in the order Q₁, Q₂, . . . Q_{N}. Bidders π(i), π(i+1), . . . , π(N) bid ε for the queries Qᵢ and the other bidders bid 0 for these queries. The optimal allocation for any permutation π remains N, by allocating the queries Qᵢ to bidder π(i). We wish to bound the expected revenue of any deterministic algorithm over inputs from the distribution D.

Fix any deterministic algorithm. Let qᵢⱼ be the fraction of queries from Qᵢ that bidder j is allocated. We have:

$${E}_{π} [ {q}_{ij} ] \leq \{ \begin{matrix}\frac{1}{N - i + 1} & if j \geq i , \\ 0 & if j < i .\end{matrix}$$

To see this, note that there are N−i+1 bidders who are bidding for queries Qᵢ. The deterministic algorithm allocates some fraction of these queries to some bidders who bid for them, and leaves the rest of the queries unallocated. If j≧i then bidder j is a random bidder among the bidders bidding for these queries and hence is allocated an average amount of

$$\frac{1}{N - i + 1}$$

of the queries which were allocated from Qᵢ (where the average is taken over random permutations of the bidders). On the other hand, if j<i, then bidder j bids 0 for queries in Qᵢ and is not allocated any of these queries in any permutation.

Thus the expected amount of money spent by a bidder j at the end of the algorithm is at most min

$$\{ 1 , {\sum }_{i = 1}^{j} \frac{1}{N - i + 1} \} .$$

By summing this over j=1, . . . , N, we get that the expected revenue of the deterministic algorithm over the distributional input D is at most N(1−1/e). This finishes the proof of the theorem.

Therefore, having thus described the invention, at least the following is claimed:

1. A method for improving the allocation of an online activity to a bidder, the method comprising determining a tradeoff value corresponding to the bidder and rating the bidder in relation to other bidders according to the tradeoff value, wherein the tradeoff value is at least partially determined according to a fraction of spent budget corresponding to the bidder.

2. The method of claim 1, wherein the tradeoff value is determined according to equation Ψ(f)=1−e^{-(1-f)}, wherein f corresponds to the fraction of spent budget.

3. The method of claim 1, wherein the tradeoff value is determined according to a monotonically decreasing function.

4. The method of claim 1, wherein the online activity corresponds to a search query.

5. The method of claim 1, wherein the online activity corresponds to an auction.

6. The method of claim 1, wherein the online activity corresponds to a purchase transaction.

7. A method for improving the allocation of an online activity to a bidder, the method comprising determining a tradeoff value corresponding to the bidder and rating the bidder in relation to other bidders according to the tradeoff value, wherein the tradeoff value is at least partially determined according to a fraction of unspent budget corresponding to the bidder.

8. The method of claim 7, wherein the tradeoff value is determined according to equation Ψ(f)=1−e^{-(1-f)} wherein f corresponds to the fraction of unspent budget.

9. The method of claim 7, wherein the tradeoff value is determined according to a monotonically decreasing function.

10. The method of claim 7, wherein the online activity corresponds to a search query.

11. The method of claim 7, wherein the online activity corresponds to an auction.

12. The method of claim 7, wherein the online activity corresponds to a purchase transaction.

13. A method for improving the allocation of an online activity to a bidder, the method comprising determining a tradeoff value corresponding to the bidder and rating the bidder in relation to other bidders according to the tradeoff value, wherein the tradeoff value is at least partially determined according to a rank of the bidder in a random permutation of total bidders.

14. The method of claim 13, wherein the tradeoff value is determined according to equation
$$ψ ( r ) = 1 - {( 1 - \frac{1}{n} )}^{n - r + 1} ,$$
wherein r is the rank of the bidder in the random permutation of n total bidders.

15. The method of claim 13, wherein the tradeoff value is determined according to a monotonically decreasing function.

16. The method of claim 13, wherein the online activity corresponds to a search query.

17. The method of claim 13, wherein the online activity corresponds to an auction.

18. The method of claim 13, wherein the online activity corresponds to a purchase transaction.

19. A method of allocating an online activity to a bidder, the method comprising:
receiving the online activity;
assigning a bid value to the bidder;
determining a tradeoff value corresponding to the bidder;
calculating a tradeoff product of the bid value and the tradeoff value; and
allocating the online activity to the bidder if the tradeoff product is greater than tradeoff products corresponding to other bidders.

20. The method of claim 19, further comprising determining the tradeoff value at least partially according to a fraction of spent budget corresponding to the bidder.

21. The method of claim 19, further comprising determining the tradeoff value according to equation Ψ(f)=1−e^{-(1-f)}, wherein f corresponds to a fraction of spent budget corresponding to the bidder.

22. The method of claim 19, further comprising determining the tradeoff value according to equation Ψ(f)=1−e^{-(1-f)}, wherein f corresponds to a fraction of unspent budget corresponding to the bidder.

23. The method of claim 19, further comprising determining the tradeoff value according to a monotonically decreasing function.

24. The method of claim 19 further comprising determining the tradeoff value according to equation
$$ψ ( r ) = 1 - {( 1 - \frac{1}{n} )}^{n - r + 1} ,$$
wherein r is a rank of the bidder in a random permutation of n bidders.

25. The method of claim 19, wherein the online activity corresponds to a search query.

26. The method of claim 19, wherein the online activity corresponds to an auction.

27. The method of claim 19, wherein the online activity corresponds to a purchase transaction.

28. The method of claim 19, further comprising associating results from the online activity with at least one advertisement corresponding to the bidder.

29. The method of claim 19, further comprising the bidder paying the bid value only if a user performs a specified action.

30. The method of claim 19, further comprising the bidder paying the bid value corresponding to a bidder having a next lower tradeoff product.

31. The method of claim 19, further comprising ordering multiple bidders according to the tradeoff product corresponding to each of the multiple bidders.

32. The method of claim 31, further comprising assigning the online activity to at least two of the multiple bidders.

33. The method of claim 31, further comprising associating at least one advertisement corresponding to at least one of the multiple bidders with results from the online activity.

34. The method of claim 31, further comprising each of the multiple bidders paying a bid value corresponding to a next bidder that is next lower in the ordering of the multiple bidders upon a user performing a specified action.

35. The method of claim 31, wherein each of the multiple bidders has a corresponding budget and at least two of the corresponding budgets are different.

36. The method of claim 31, further comprising allocating the multiple online activities wherein each of the multiple bidders retains at least a fraction of a budget corresponding to that one of the multiple bidders.

37. The method of claim 31, further comprising adding at least one bidder to the multiple bidders at a time separate from at least one other bidder.

38. The method of claim 31, further comprising removing at least one bidder from the multiple bidders at a time separate from at least one other bidder.

39. A system for allocating an on-line activity to a bidder, the system comprising:
means for receiving the online activity;
means for assigning a bid value to the bidder;
means for determining a tradeoff value corresponding to the bidder;
means for calculating a tradeoff product of the bid value and the tradeoff value; and
means for allocating the online activity to the bidder if the tradeoff product is greater than tradeoff products corresponding to other bidders.

40. The system of claim 39, further comprising that the tradeoff value is at least partially determined according to a fraction of spent budget corresponding to the bidder.

41. The system of claim 39, further comprising that the tradeoff value is determined according to equation Ψ(f)=1−e^{-(1-f}), wherein f corresponds to a fraction of spent budget corresponding to the bidder.

42. The system of claim 39, further comprising that the tradeoff value is determined according to equation Ψ(f)=1−e^{-f)}, wherein f corresponds to a fraction of unspent budget corresponding to the bidder.

43. The system of claim 39, further comprising that the tradeoff value is determined according to a monotonically decreasing function.

44. The system of claim 39, further comprising that the tradeoff value is determined according to equation
$$ψ ( r ) = 1 - {( 1 - \frac{1}{n} )}^{n - r + 1} ,$$
wherein r is a rank of the bidder in a random permutation of n bidders.

45. The system of claim 39, wherein the online activity corresponds to a search query.

46. The system of claim 39, wherein the online activity corresponds to an auction.

47. The system of claim 39, wherein the online activity corresponds to a purchase transaction.

48. The system of claim 39, further comprising that at least one advertisement corresponding to the bidder is associated with results from the online activity.

49. The system of claim 39, further comprising that the bidder pays the bid value only upon a user specified action.

50. The system of claim 39, further comprising that the bidder pays the bid value of a bidder having a next lower tradeoff product.

51. The system of claim 39, further comprising multiple bidders, the multiple bidders being ordered according to the tradeoff product corresponding to each of the multiple bidders.

52. The system of claim 51, further comprising an online activity assigned to at least two of the multiple bidders.

53. The system of claim 51, further comprising that at least one advertisement corresponding to at least one of the multiple bidders are associated with results from the online activity.

54. The system of claim 51, further comprising that each of the multiple bidders pays a bid value corresponding to a next bidder that is next lower in the ordering of the multiple bidders upon a user specified action.

55. The system of claim 51, wherein each of the multiple bidders has a corresponding budget and at least two of the corresponding budgets are different.

56. The system of claim 51, further comprising multiple online activities wherein each of the multiple bidders retains at least a fraction of a budget corresponding to that one of the multiple bidders after allocation of the multiple online activities.

57. The system of claim 51, further comprising adding at least one bidder to the multiple bidders at a time separate from at least one other bidder.

58. The system of claim 51, further comprising removing at least one bidder from the multiple bidders at a time separate from at least one other bidder.

59. A method of allocating an online activity to a bidder where there are multiple bidders, the method comprising:
receiving the online activity;
assigning a weighted value to each of the multiple bidders;
determining an effective bid value corresponding to each of the multiple bidders where the effective bid value is the product of the bid value for each of the multiple bidders and the weighted value corresponding to that respective multiple bidder; and
allocating the online activity to the bidder according to an ordering of the effective bid values.

60. The method of claim 59, wherein assigning the weighted value further comprises:
assigning all bidder weighted values to an initial value;
setting a window of time;
adjusting the weighted values after each window of time by increasing the weighted value if the corresponding bidder spends less than a first specified value during the window of time, and decreasing the weighted value if the corresponding bidder spends more than a second specified value during the window of time.

61. The system of claim 59, wherein the online activity corresponds to a search query.

62. The system of claim 59, wherein the online activity corresponds to an auction.

63. The system of claim 59, wherein the online activity corresponds to a purchase transaction.
